(19) United States
(12) Patent Application Publication
(10) Pub. No.: US 2006/0103350 A1
(43) Pub. Date: May 18, 2006

(54) [AN EQUALIZING-CHARGE CHARGER]

(75) Inventor: Chun-Chung Lai, TAIPEI (TW)

Correspondence Address: AKKU POWER LIMITED COMPANY, 2F-4, NO. 148, SEC. 4, CHUNG HSIAO EAST ROAD, TAIPEI, TW

(73) Assignee: AKKU POWER ELECTRONIC CO., LTD., Nei-Hu District, Taipei City. (TW)

(21) Appl. No.: 10/904,473

(22) Filed: Nov. 12, 2004

(51) Int. Cl. H02J 7/00

(52) U.S. Cl. 320/118; 320/141

(57) ABSTRACT

Disclosed is an equalizing-charge charger includes a microprocessor, a pulse width modulator, battery cells, and equalizing charge load-control switches corresponding to the battery cells. When voltage sensors of the microprocessor detected the saturated status of one battery cell during charging mode, the microprocessor controls the pulse width modulator to stop the charging action and counts the voltage value of each battery cell to find the battery cell having the lowest voltage value, and then switches on the equalizing charge load-control switch corresponding to the saturated battery cell to discharge the saturated battery cell to the voltage value equal to the battery cell having the lowest voltage value, and then starts the pulse width modulator to charge the battery cells again, and then repeats the procedure again and again until the voltage value of the battery cells has been equalized and battery cells have been charged to saturated status.

### BACKGROUND OF THE INVENTION

1. Field of the Invention

The present invention relates to chargers and more particularly, to an equalizing-charge charger, which has a microprocessor capable of discharging the battery cells individually for enabling the battery cells to be equally charged to the saturated status, preventing an overcharge.

2. Description of the Related Art

Following fast development of high technology, a variety of mobile electronic devices (such as Personal Digital Assistant-PDA, digital camera, mobile CD player, and etc.) have been disclosed and have appeared on the market. These advances mobile electronic devices commonly meet the requirements of modern electronic features such as light, short, thin, small and versatile functions. To fit mobile electronic devices, high-capacity battery cells are developed. For charging high-capacity battery cells, a high-performance charger shall be used. It is the market tendency to develop compact and high-performance charger that are inexpensive.

FIG. 1 is a circuit block diagram of a charger according to the prior art. According to this design, the charger comprises a power adapter 11 adapted to convert input AC 110V˜240V into DC 4.2˜16.8V, and a charging circuit 12 electrically connected to the output end of the power adapter 111 and adapted to charge a series of battery cells 21-24 with the power DC 4.2˜16.8V. This design of charger has the advantages of simple structure and low manufacturing cost. However, this design of charger is still not satisfactory in function because it cannot charge all the battery cells equally to the saturated status. This design of charger cannot eliminate overcharge of the battery cells. When one battery cell reached the saturated status, the other battery cells may be still not fully charged. Frequently charging a battery cell to an unsaturated status will shorten the service life of the battery cell.

This problem is well understood from the explanation shown in FIG. 2. When charging the battery cells with a constant voltage, the amount of electric current will be gradually reduced following the saturation status of the battery cells. However, because the battery cells are connected in series, the charging circuit keeps charging the saturated battery cell and the voltage value of the other battery cells keeps rising (not reaching the saturated status), thereby causing an overcharge of the saturated battery cell. When one of the battery cells is abnormal, an accident may occur easily.

Therefore, it is desirable to provide an equalizing-charge charger that eliminates the aforesaid problem.

### SUMMARY OF THE INVENTION

The present invention has been accomplished under the circumstances in view. It is therefore the main object of the present invention to provide an equalizing-charge charger, which is capable of discharging the battery cells individually for enabling the battery cells to be equally charged to the saturated status, preventing an overcharge.

To achieve this and other objects of the present invention, the equalizing-charge charger comprises a microprocessor, which has a plurality of voltage sensors for detecting the voltage value of a respective battery cell connected thereto, a pulse width modulator electrically connected to an external power source and the microprocessor and controllable by the microprocessor to modulate input power from the external power source into current-limit constant-voltage power for output to charge battery cells connected thereto, a plurality of battery cells electrically connected to the pulse width modulator and the voltage sensors of the microprocessor and chargeable by outputted current-limit constant-voltage power from the pulse width modulator, and a plurality of equalizing charge load-control switches respectively electrically connected between the microprocessor and the battery cells. When the voltage sensors detected the saturated status of one of the battery cells during charging of the battery cells by the pulse width modulator, the microprocessor controls the pulse width modulator to stop the charging action and counts the voltage level of each battery cell to find the battery cell having the lowest voltage value, and then switches on the equalizing charge load-control switch corresponding to the saturated battery cell to discharge the saturated battery cell to the voltage value equal to the battery cell having the lowest voltage value, and then starts the pulse width modulator to charge the battery cells again, and then repeats the procedure again and again until the voltage value of the battery cells has been equalized and battery cells have been charged to saturated status.

### BRIEF DESCRIPTION OF THE DRAWINGS

FIG. 1 is a circuit block diagram of a charger according to the prior art.

FIG. 2 is a schematic drawing explaining the battery saturation point.

FIG. 3 is a circuit block diagram of an equalizing-charge charger according to the present invention.

FIG. 4 is an operation flow chart of the present invention.

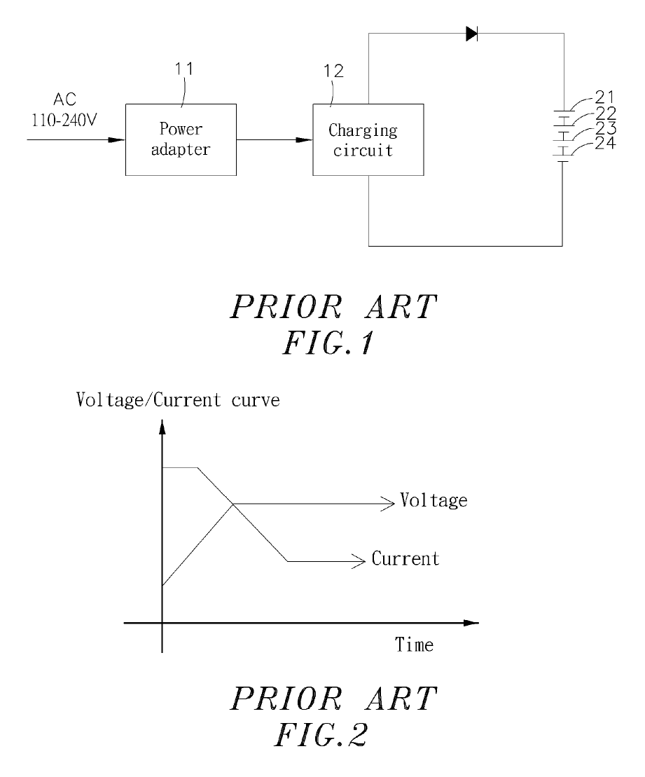

### DETAILED DESCRIPTION OF THE EMBODIMENT

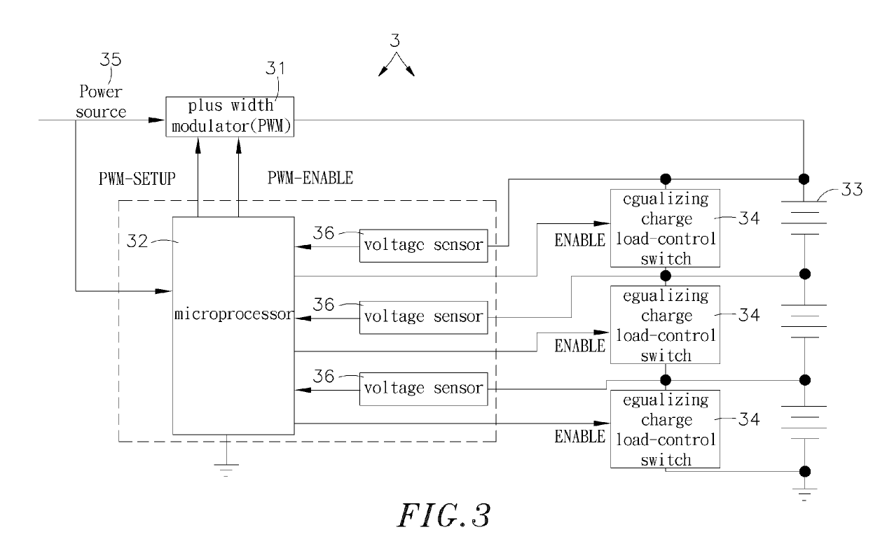

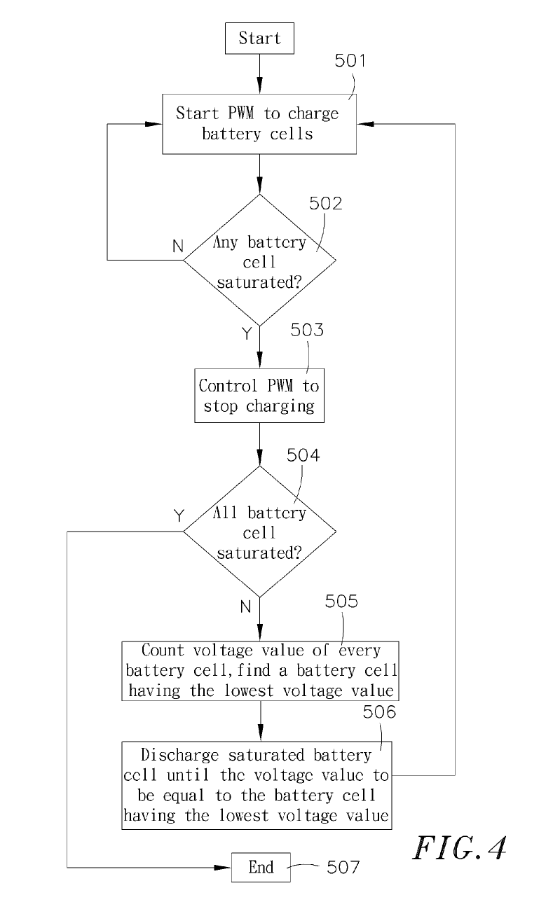

Referring to FIGS. 3 and 4, an equalizing-charge charger 3 in accordance with the present invention is shown comprising a pulse width modulator (PWM) 31 adapted to modulate input power into current-limit constant-voltage power for output, a microprocessor 32, a plurality of battery cells 33, and a plurality of equalizing charge load-control switches 34 corresponding to the battery cells 33. The pulse width modulator (PWM) 31 is electrically connected to power source 35 and the microprocessor 32. The power source 35 is processed through the pulse width modulator (PWM) 31 for output. The microprocessor 32 controls the pulse width modulator (PWM) 31 to provide a current-limit constant-voltage output. The pulse width modulator (PWM) 31 is also electrically connected to the battery cells 33. The battery cells 33 are respectively electrically connected to the equalizing charge load-control switches 34. The equalizing charge load-control switches 34 are respectively electrically connected to the microprocessor 32. The battery cells 33 are respectively electrically connected to respective voltage sensors 36 of the microprocessor 32 so that each voltage sensor 36 can detect the voltage level of the respective battery cell 33.

Referring to FIG. 3 again, during charging operation of the equalizing-charge charger 3, the microprocessor 32 controls the output of the pulse width modulator (PWM) 31 to charge the battery cells 33. When the voltage sensors 36 detected the saturated status of one battery cell 33 (i.e., the battery cell reached the limited voltage value), the microprocessor 32 controls the pulse width modulator (PWM) 31 to stop the charging action and counts the voltage value of each battery cell 33 to find the battery cell 33 having the lowest voltage value, and then switches on the equalizing charge load-control switch 34 corresponding to the saturated battery cell 33 to discharge the saturated battery cell 33 to the voltage value equal to the battery cell 33 having the lowest voltage value, and then starts the pulse width modulator (PWM) 31 to charge the battery cells 33 again. This procedure is repeated again and again until the voltage value of the battery cells 33 has been equalized and battery cells have been charged to saturated status.

Referring to FIG. 3 again, during a discharging action, the microprocessor 32 controls the pulse width modulator (PWM) to stop the charging action and switches on equalizing charge load-control switch 34 to run the discharge operation until the voltage values of the battery cells 33 have been equalized. The microprocessor 32 can set a tolerance value subject to the chemical characteristics of the battery cells 33. When the voltage value of every battery cell 33 reaches the range within the tolerance value, the voltage values of the battery cells 33 are regarded equalized. This feature prevents overcharge of the battery cells 33, thereby prolonging the service life of the battery cells 33.

Referring to FIG. 3 again, the microprocessor 32 of the equalizing-charge charger 3 can repeatedly adjust the voltage value of each battery cell 33 to an equalizing status while charging the battery cells 33, enabling the battery cells 33 to be equally charged to the saturated status voltage value (for example, 4.2V±20 mV).

Referring to FIG. 4 and FIG. 3 again, when operating the equalizing-charge charger 3 to start the charging mode, the microprocessor 32 runs subject to the following steps:

starting;

501 starting the pulse width modulator (PWM) 31 to output an electric current to charge the battery cells 33;

502 judging if there is any one of the battery cells 33 reached the saturated status? and then proceeding to step 503 if positive or returning to step 501 if negative;

503 controlling the pulse width modulator (PWM) 31 to stop the charging action;

504 judging if all battery cells 33 have reached the saturated status or not? and then proceeding to step 507 if positive or proceeding to step 505 if negative;

505 counting the voltage value of every battery cell 33 to find the one having the lowest voltage value;

506 discharging the saturated battery cell(s) 33 to the voltage value equal to the battery cell 33 having the lowest voltage value, and then returning to step 501;

507 End.

Further, the aforesaid power source 35 can be AC power supply or DC power supply.

As indicated above, the invention utilizes a discharging mode to equalize the voltage value of the battery cells, enabling the battery cells to be all equally charged to the saturated status without causing an overcharge. Further, the invention controls the pulse width modulator (PWM) to provide a current-limit constant-voltage output to charge the battery cells rapidly and safely.

A prototype of equalizing-charge charger has been constructed with the features of FIGS. 3 and 4. The equalizing-charge charger functions smoothly to provide all of the features discussed earlier.

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. An equalizing-charge charger comprising
a microprocessor, said microprocessor having a plurality of voltage sensors for detecting the voltage value of a respective battery cell connected thereto;
a pulse width modulator (PWM) electrically connected to an external power source and said microprocessor and controllable by said microprocessor to modulate input power from said external power source into current-limit constant-voltage power for output to charge battery cells connected thereto;
a plurality of battery cells electrically connected to said pulse width modulator and said voltage sensors of said microprocessor and chargeable by outputted current-limit constant-voltage power from said pulse width modulator; and
a plurality of equalizing charge load-control switches respectively electrically connected between said microprocessor and said battery cells;
wherein when said voltage sensors detected the saturated status of one of said battery cells during charging of said battery cells by said pulse width modulator, said microprocessor controls said pulse width modulator to stop the charging action and counts the voltage value of each of said battery cells to find the battery cell having the lowest voltage value, and then switches on the equalizing charge load-control switch corresponding to the saturated battery cell to discharge the saturated battery cell to the voltage value equal to the battery cell having the lowest voltage value, and then starts said pulse width modulator to charge said battery cells again, and then repeats the procedure again and again until the voltage value of said battery cells has been equalized.

2. The equalizing-charge charger as claimed in claim 1, wherein said microprocessor is controllable to repeatedly adjust the voltage value of each of said battery cells to an equalizing status while charging said battery cells, enabling said battery cells to be equally charged to the saturated voltage value (4.2V±20 mV).

3. The equalizing-charge charger as claimed in claim 1, wherein said microprocessor is controllable to set a tolerance value so that when the voltage value of every one of said battery cells reaches the range within said tolerance value, the voltage values of said battery cells are regarded equalized to prevent overcharge of said battery cell and prolong the service life of said battery cells.

4. The equalizing-charge charger as claimed in claim 1, wherein said external power source is a DC power source.

5. The equalizing-charge charger as claimed in claim 1, wherein said external power source is AC power source.

6. An equalizing-charge charger comprising:
a microprocessor, said microprocessor having a plurality of voltage sensors for detecting the voltage value of a respective battery cell connected thereto;
a pulse width modulator (PWM) electrically connected to an external power source and said microprocessor and controllable by said microprocessor to modulate input power from said external power source into current-limit constant-voltage power for output to charge battery cells connected thereto;
a plurality of battery cells electrically connected to said pulse width modulator and said voltage sensors of said microprocessor and chargeable by outputted current-limit constant-voltage power from said pulse width modulator; and
a plurality of equalizing charge load-control switches respectively electrically connected between said microprocessor and said battery cells;
wherein said microprocessor runs subject to the following steps when controlling said pulse width modulator to charge said battery cells:
(a) starting said pulse width modulator to output an electric current to charge said battery cells;
judging if there is any one of said battery cells reached the saturated status? and then proceeding to following step (c) if positive;
controlling said pulse width modulator to stop the charging action;
judging if all said battery cells have reached the saturated status or not? and then proceeding to follow step (g) if positive or step (e) if negative;
counting the voltage value of every said battery cell to find the one having the lowest voltage value;
discharging said saturated battery cell to the voltage value equal to the battery cell having the lowest voltage value, and then returning to step (a); and
ending the procedure.

7. The equalizing-charge charger as claimed in claim 6, wherein said microprocessor returns to step (a) if the result of judgment is negative during step (b).
